(19) United States
(12) Patent Application Publication
(10) Pub. No.: US 2026/0188635 A1
(43) Pub. Date: Jul. 2, 2026

(54) ION DETECTION SYSTEMS FOR DETECTING IONS EMITTED FROM ION ANALYZERS

(71) Applicant: El-Mul Technologies Ltd, Rehovot (IL)

(72) Inventors: Amit Weingarten, Rehovot (IL); Semyon Shofman, Rehovot (IL); Alexander Kadyshevitch, Rehovot (IL)

(21) Appl. No.: 19/436,564

(22) Filed: Dec. 30, 2025

(30) Foreign Application Priority Data
Dec. 31, 2024 (IL) 318126

(51) Int. Cl. H01J 49/02; H01J 49/00; H01J 49/06; H01J 49/20; H01J 49/22

(52) U.S. Cl. CPC H01J 49/025; H01J 49/0086; H01J 49/063; H01J 49/067; H01J 49/20; H01J 49/22

(57) ABSTRACT

An ion detection system for detecting primary ions emitted from an exit opening of an ion analyzer, comprising an electrically biasable converter assembly being operable to generate secondary electrons upon impingement of the primary ions thereon, an electrical shield mechanism operable to reduce the electric field generated by the converter assembly on the exit opening, a particle selector formed with an exit aperture and is operable to direct the secondary electrons out of the exit aperture and to prevent propagation of secondary ions generated by the converter assembly, through the exit aperture and an a sensor unit operable for impingement thereon of the secondary electrons exiting the exit aperture and for generating a signal indicative of the primary ions

### CROSS-REFERENCE TO RELATED APPLICATIONS

This application claims priority benefit from Israel Application No. 318126, filed Dec. 31, 2024, entitled “Ion Detection Systems for Detecting Ions Emitted from Ion Analyzers” the disclosure of which is incorporated herein by reference in its entirety.

### TECHNICAL FIELD

The present disclosure generally relates to ion detection systems, and particularly to ion detection systems for detecting ions emitted from ion analyzers.

### BACKGROUND

References considered to be relevant as background to the present disclosure are listed below.
U.S. Pat. No. 7,180,060; and
U.S. Pat. No. 11,640,005

Acknowledgement of the above references herein is not to be inferred as meaning that these are in any way relevant to the patentability of the present disclosure.

### GENERAL DESCRIPTION

According to a first aspect of the present disclosure there is provided an ion detection system operative to detect ions emitted from an ion analyzer used in mass spectrometry.

The term “primary ion” in the context of this disclosure includes an ion initially generated or emitted from an ion source within the ion analyzer. The term “secondary ion” includes an ion that is generated as a result of the interaction between a primary ion and a material or medium. The primary ion and secondary ion may include a positive ion and a negative ion.

The term “secondary electron” includes an electron that is generated as a result of the interaction between a primary particle, namely an ion or electron, and a material or medium.

In some non-limiting examples, ion analyzers are systems operable to separate different types of ions based on their mass-to-charge ratio (m/z). In some embodiments the ion analyzers separate the different types of ions based upon the stability of motion within an oscillating electric field. The oscillating electric field is operable to selectively stabilize or destabilize ion trajectories according to their mass-to-charge ratio (m/z), thereby differentiating the various types of ions of specific mass-to-charge ratios. Non-limiting examples of ion analyzers comprise any one of a quadrupole and an ion trap. The quadrupole comprises four parallel rods operative to generate an electric field, commonly used to differentiate various types of ions based on their mass-to-charge ratio. An ion trap operates by generating a dynamic electric field, and in some embodiments is combined with a magnetic field, that creates a potential well to confine ions. By adjusting the frequency and amplitude of the electric field, the ion trap selectively stabilizes the trajectories of ions with specific mass-to-charge ratios while destabilizing and rejecting others, thereby enabling differentiation of ions based on their specific mass-to-charge ratios.

In accordance with an embodiment of the present disclosure, primary ions emitted from the ion analyzer propagate to an ion detection system operative to detect the quantity of the mass-differentiated primary ions by a sensor unit operative to detect secondary electrons converted in an ion-to-electron converter assembly.

The ion-to-electron converter assembly is operable to generate secondary electrons upon impingement of the primary negative and/or positive ions thereon. In some embodiments, the converter assembly is operable to directly convert the primary positive or negative ions impinging thereon to secondary electrons, without an intermediate conversion stage. The intermediate conversion stage is conventionally practiced by initially converting a negative ion first to a positive ion and thereafter to a secondary electron. The direct conversion may be facilitated by providing an electrically biasable converter assembly at dual polarities, namely the converter assembly is selectively, electrically biasable to attract a negative ion and a positive ion, asynchronously, by selecting the electrical potential on the components of the converter assembly. When biasing the components of the converter assembly at a negative charging mode, negative ions will be attracted thereto and will be converted to secondary electrons, when impinging thereon. When biasing the components of the converter assembly at a positive charging mode, positive ions will be attracted thereto and will be converted to secondary electrons when impinging thereon.

During conversion, secondary ions may be emitted, thereby generating undesired noise while detecting the secondary electrons by the sensor unit and degrading the sensor unit. The ion detection system comprises a particle selector operative to select one type of particle from another type of particle. Examples of particles can be electrons, e.g. secondary electrons, and ions, e.g. secondary ions.

The particle selector is operative to direct the secondary electrons to the sensor unit and to prevent propagation of secondary ions to the sensor unit, thus minimizing the detection of the secondary ions by the sensor unit.

The particle selector may comprise a beam separator. The beam separator may comprise a particle deflector operative to manipulate the trajectory of the particles, namely the secondary ions and the secondary electrons, based in their velocity and/or mass. Accordingly, the particle selector is operative to cause the secondary ion to remain within the particle selector and cause the secondary electron to exit the particle selector to the sensor unit.

In some embodiments the particle selector comprises a magnetic field or an electric field for manipulating the trajectory of the particles. In some embodiments the particle selector comprises crossed electric and magnetic fields for manipulating the trajectory of the particles. The magnetic field, the electric field and/or the crossed electric and magnetic fields, may be fields forming part of the ion detection system and are auxiliary to the ion analyzer, namely they may be provided in addition to the magnetic field, the electric field and/or the crossed fields of the ion analyzer.

Introducing an electrical field in proximity to the ion analyzer may interfere with the electrical field of the ion analyzer.

In some embodiments there is provided an electrical shield mechanism operable to reduce, minimize or isolate the electrical field, generated by the converter assembly, from the ion analyzer. The electrical shield mechanism may be positioned intermediate the ion analyzer and the converter assembly. In some embodiments, the electrical shield mechanism may comprise a gap formed between the ion analyzer and the converter assembly, configured at a distance which will at least reduce, and in some embodiments, prevent electrical interference of the electrical field generated by the converter assembly on the ion analyzer. In some embodiments, the electrical shield mechanism comprises one or more electrodes positioned intermediate the ion analyzer and the converter assembly and is biasable to a potential which will at least reduce, and in some embodiments, prevent electrical interference of the electrical field generated by the converter assembly on the ion analyzer.

The sensor unit may be operable for impingement thereon of the secondary electrons and for generating a signal indicative of the primary ions. The sensor unit may be operative to convert the secondary electrons impinging thereon to photons, which are thereafter detected by a light sensor, thereby generating a signal indicative of the primary ions.

In accordance with a second aspect of the present disclosure, the ion detection system for detecting primary ions emitted from an ion analyzer, comprises a converter assembly operative to directly convert the primary ions to secondary electrons and further comprises a particle selector operable to direct the secondary electrons to a sensor unit and to prevent propagation of secondary ions to the sensor unit, and yet further comprises the sensor unit operative to convert the secondary electrons impinging thereon to photons which are detected by a light sensor, thereby generating a signal indicative of the primary ions. Such an ion detection system may comprise some or all of the following features:

Overall reduction of noise, at least partially due to the direct conversion of the primary ions to secondary electrons by the converter assembly and due to the particle selector, which prevents secondary ions from propagating to the sensor unit.

Gain of the primary ions achieved at least by the conversion of the primary ions to secondary ions in the conversion assembly and further by the conversion of the secondary electrons to the light signal (photons) by the sensor unit.

Higher conversion efficiency, at least partially due to the direct conversion of the primary ions to secondary electrons by the converter assembly, since primary ions are more effectively converted into secondary electrons than into secondary ions.

Longer lifespan of a sensor comprising a scintillator impinged thereon by the secondary electrons compared to known sensors such as MCP, dynodes and electron multipliers. These known sensors typically have a shorter lifespan. Furthermore, impingement on the scintillator mainly by secondary electrons while preventing propagation of secondary ions to the scintillator, may prolong the lifespan of the scintillator since degeneration by ions is avoided. In a non-limiting example, the standard lifespan of a conventional ion detection system is 3 months to 2 years, while the ion detection system comprising the features according to the second aspect of the present disclosure can potentially be endless.

Furthermore, the components of the ion detection system are compact. As will be described, in some embodiments, the components of the converter assembly and the particle selector may be combined resulting in a compact, small sized system, which can be inserted into a chamber of a mass spectrometry.

It is appreciated that in some embodiments the ion detection system may only comprise some and not all of the above features. For example, the sensor unit may comprise a dynode or a MCP (microchannel plate). In another embodiments the converter assembly may be operative to convert the primary ions in a number of stages such as initially from negative ions to positive ions and thereafter to secondary electrons. In some embodiments, the converter assembly may be operative to convert primary ions to secondary ions and the sensor unit may be operative to detect ions impinging thereon.

### EMBODIMENTS

A more specific description is provided in the Detailed Description whilst the following are non-limiting examples of different embodiments of the present disclosure.

1. An ion detection system for detecting primary ions emitted from an exit opening of an ion analyzer, comprising:
an electrically biasable converter assembly being operable to generate secondary electrons upon impingement of the primary ions thereon;
an electrical shield mechanism operable to reduce the electric field generated by the converter assembly on the exit opening;
a particle selector formed with an exit aperture and is operable to direct the secondary electrons out of the exit aperture and to prevent propagation of secondary ions generated by the converter assembly, through the exit aperture; and
a sensor unit operable for impingement thereon of the secondary electrons exiting the exit aperture and for generating a signal indicative of the primary ions.
   2. The system according to embodiment 1, wherein the particle selector comprises crossed electric and magnetic fields operable to perform said directing of the secondary electrons out of the exit aperture and said preventing the propagation of the secondary ions through the exit aperture.
   3. The system according to embodiment 1 or 2, wherein the converter assembly comprises:
an entrance plate formed with an entrance aperture for allowing passage therethrough of the primary ion emitted from the exit opening; and
a converter plate and a converter member supported by the converter plate.
   4. The system according to embodiment 3, wherein the particle selector comprises an exit plate formed with the exit aperture.
   5 The system according to embodiment 4, wherein the converter plate is arranged at a first distance from the entrance plate and the exit plate is more proximal to the exit opening.
   6. The system according to embodiment 5, wherein a maximum axial distance Yₘₐₓ of the first distance between the converter plate and the entrance plate is strictly under

$$3 \cdot \frac{D ( \frac{m}{q} )}{B} ,$$

preferably strictly under

$$2 \cdot \frac{D ( \frac{m}{q} )}{B} .$$

7. The system according to embodiment 5 or 6, wherein a maximum distance Xₘₐₓ of a second distance between the converter plate and the exit aperture is in the range of, including the minimal and maximal values:

$$2 * 1 {0}^{- 11} \frac{V}{{B}^{2} d} \leq X max \leq {10}^{- 10} \frac{V}{{B}^{2} d} .$$

in which Vis the voltage in Volts between the entrance plate and the conversion plate d is the distance between the entrance plate and the conversion plate in meters, D1, B is the value of the magnetic field expressed in Tesla.
8. The system according to any one of embodiments 5 to 7, wherein each of the converter plate and the exit plate is electrically biasable relative to the entrance plate to create the electric field in a region formed by said first distance.
9. The system according to embodiment 8, wherein the particle selector comprises a magnet assembly providing the magnetic field within the region.
10. The system according to embodiment 9, wherein the magnet assembly is formed by walls within which the magnetic field is formed, the system being configured to impose a predetermined said electric field crossed with said magnetic field within said walls, a geometry of the walls, the magnetic field, and the predetermined electric field being configured such that at least a majority of the secondary ions impinge at least one of the walls.
11. The system according to any one of embodiments 5 to 10, wherein:
the first distance extends along a longitudinal axis of the system, the converter plate and the exit plate are positioned along a lateral axis of the system,
the electric field is generated along the longitudinal axis, and
the magnetic field is generated along a latitudinal axis which is orthogonal to the longitudinal axis and the lateral axis.
   12. The system according to any one of embodiments 2 to 11 when dependent on embodiment 2, wherein a resultant field of the crossed electric and magnetic fields is configured to separate the secondary electrons from the secondary ions based on a velocity differential between the secondary electrons and the secondary ions.
   13. The system according to embodiment 12, wherein the resultant field is operable to:
guide the secondary electrons along a first trajectory that directs the secondary electrons through the exit aperture, and
guide the secondary ions along a second trajectory that diverts the secondary ions away from the exit aperture.
   14. The system according to any one of embodiments 1 to 13, wherein the primary ions are emitted from the ion analyzer at low energies in the range of 0-100 volts.
   15. The system according to any one of embodiments 1 to 14, wherein the ion analyzer is operable to separate different types of primary ions based on their stability of motion within an oscillating electric field.
   16. The system according to any one of embodiments 1 to 15, wherein the primary ions are emitted from the ion analyzer comprising any one of a quadrupole and an ion trap.
   17. The system according to any one of embodiments 1 to 16, wherein the electrical shield mechanism isolates the exit opening from the converter assembly.
   18. The system according to any one of embodiments 3 and embodiments 4 to 17 when dependent on embodiment 3, wherein the electrical shield mechanism comprises a gap formed between the exit opening and the entrance plate.
   19. The system according to embodiment 18, wherein the gap comprises a length at least 1 millimeter long for every 100 volt on the entrance plate.
   20. The system according to any one of embodiments 1 to 19, wherein the electrical shield mechanism comprises at least one electrode positioned axially intermediate the exit opening and the converter assembly and is formed with an electrode opening axially aligned with the exit opening.
   21. The system according to embodiment 20, wherein the electrode comprises an accelerator for acceleration of the primary ions from the exit opening towards the converter assembly.
   22. The system according to any one of embodiments 1 to 21, wherein the sensor unit comprises a scintillator formed with a scintillating surface for generating a photon upon impingement of the secondary electron thereon and a light guide for passage of the photons therethrough to a photomultiplier tube operative to generate said signal based upon the photons.
   23. The system according to any one of embodiments 1 to 22, wherein the converter assembly is selectively electrically biasable in dual polarity modes including: a positive mode operable for attracting positive primary ions thereto; and a negative mode operable for attracting negative primary ions thereto.
   24. The system according to any one of embodiments 1 to 23, wherein the converter assembly is operable to directly convert positive primary ions and negative primary ions directly to secondary electrons, free of intermediate conversion stages.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a simplified illustration of an ion detection system, constructed and operative according to an embodiment of the present disclosure;

FIG. 2 is a simplified illustration of another ion detection system, constructed and operative according to an embodiment of the present disclosure;

FIG. 3 is a simplified illustration of yet another ion detection system, constructed and operative according to an embodiment of the present disclosure;

FIG. 4 is a simplified illustration of a biasing scheme of the ion detection system of FIG. 3, constructed and operative according to an embodiment of the present disclosure;

FIG. 5 is a simplified illustration of a mass spectrometry device comprising the ion detection system shown in FIG. 3; and

FIG. 6 is the mass spectrometry device of FIG. 5 with portions removed.

### DETAILED DESCRIPTION OF EMBODIMENTS

In the following description, various aspects of the present disclosure will be described. For purposes of explanation, specific configurations and details are set forth in order to provide a thorough understanding of the present disclosure. However, it will also be apparent to one skilled in the art that the present disclosure may be practiced without the specific details presented herein. Furthermore, well known features may be omitted or simplified in order not to obscure the present disclosure.

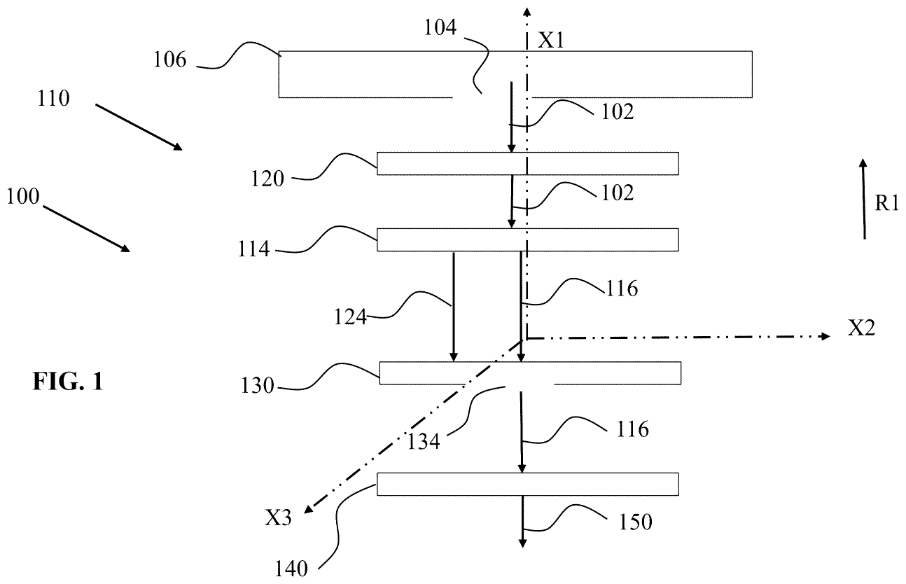

As seen in FIG. 1, an ion detection system 100 is provided for detecting primary ions 102 emitted from an exit opening 104 of an ion analyzer 106 forming part of a mass spectrometry device 110.

The ion detection system 100 extends along a longitudinal axis X1, a lateral axis X2 and a latitudinal axis X3, which is orthogonal to the longitudinal axis X1 and the lateral axis X2.

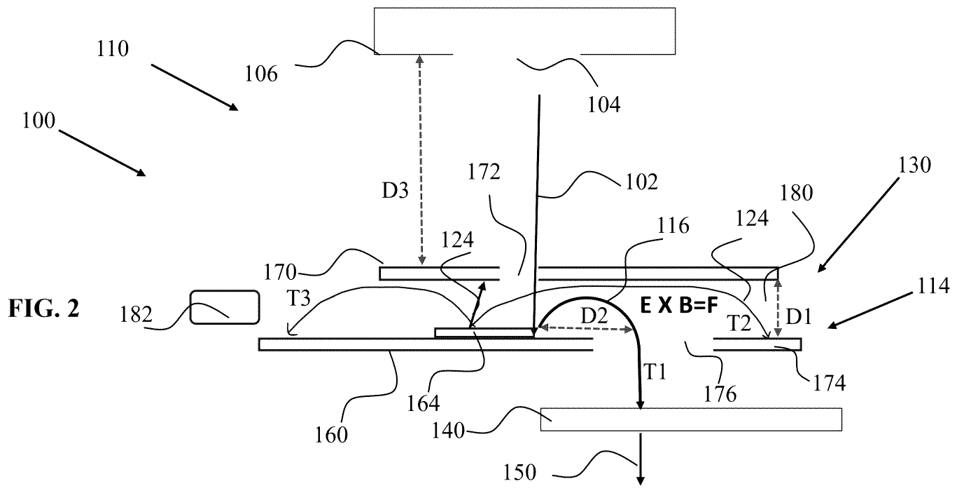

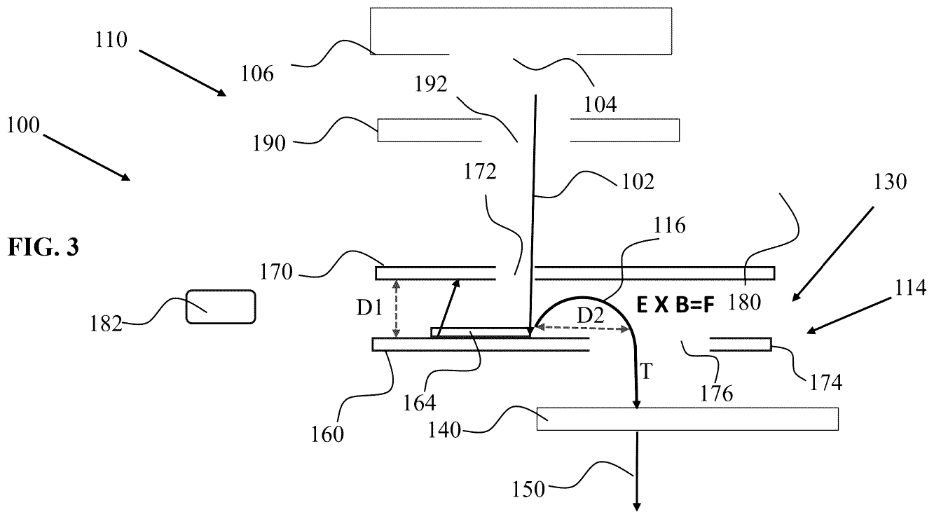

The ion detection system 100 comprises an electrically biasable converter assembly 114 being operable to generate secondary electrons 116 upon impingement of the primary ions 102 thereon. In some embodiments, conversion of the primary ions in the converter assembly 114 yields a gain in the quantity of generated secondary electrons. The converter assembly 114 may generate an electric field along the longitudinal axis X1 towards the exit opening 104 in a first Direction R1, which may cause undesired charging of the ion analyzer 106. An electrical shield mechanism 120 is provided and operable to reduce the potential on the exit opening 104. Examples of electrical shield mechanisms 120 are further described with reference to FIGS. 2 and 3.

During conversion of the primary ions 102 by the conversion assembly 114, secondary ions 124 may inadvertently be generated thereby. A particle selector 130 is formed with an exit aperture 134 for exit of particles therefrom towards a sensor unit 140. The particle selector 130 is operable to direct the secondary electrons 116 out of the exit aperture 134 and to prevent propagation of secondary ions 124 through the exit aperture 134.

The sensor unit 140 is operable for impingement thereon of the secondary electrons 116 exiting the exit aperture 134 and for generating a signal 150 indicative of the primary ions 102.

The converter assembly may comprise any configuration operative to convert the primary ions to secondary electrons. Examples of such a conversion assembly include dynodes, MCPs and electron multipliers.

The particle selector comprises any arrangement which allows the secondary electrons to propagate to the sensor unit and prevents the secondary ions from advancing to the sensor unit. The particle sensor may comprise an arrangement operative to separate the ions from the electrons based on a velocity or mass differential between the heavier and slower ions and the lighter weight and faster electrons. The arrangement may further be configured to direct the electrons thereout and maintain the ions therewithin. In some embodiments, the converter assembly and the particle selector may be mutually arranged to operate together to convert the primary ions to secondary electrons and to direct them to the sensor unit.

In the example shown in FIGS. 2 and 3, it is seen that in some embodiments, the converter assembly 114 comprises a converter plate 160 and a converter member 164 supported by the converter plate 160. The converter member 164 comprises a mechanism, such as a material configured for converting ions to electrons. In a non-limiting example, the converter member may comprise a conductive material, such as stainless steel or aluminum, which emits secondary electrons upon ion impingement thereon. In some embodiments, the entire converter plate 160 comprises the converter member 164.

The particle selector 130 comprises an entrance plate 170 formed with an entrance aperture 172 for allowing passage therethrough of the primary ions 102 to an exit plate 174 formed with an exit aperture 176. The entrance plate 170 is shown to be positioned along the longitudinal axis X1 at a first axial distance D1 from the exit plate 174 and/or converter plate 160. Entrance plate 170 is positioned intermediate the exit opening 104 and the exit plate 174. The converter plate 160 is arranged adjacent the exit plate 174 along the same lateral axis X2, such that the converter plate 160 is positioned at the first distance D1 from the entrance plate 170.

In some embodiments, the converter plate 160 and the exit plate 174 are monolithically formed of the same continuous plate. The exit aperture 176 is shown to be positioned along the lateral axis X2 at a second lateral distance D2 from the converter member 164. The converter member 164 is axially aligned with the entrance aperture 172 to allow primary ions 102 to propagate therethrough to be converted by the converter member 164 to secondary electron 116.

It is appreciated that the positioning of the entrance plate, the converter plate and the exit plate can be performed in other arrangements.

In some embodiments, one or both of the converter plate 160 and the exit plate 174 are electrically biasable relative to the entrance plate 170 to create an electric field E in a region 180 defined at the first distance D1.

The particle selector 130 may further comprise a magnetic field B arranged orthogonally to the electric field E. In the example shown in FIGS. 2 and 3, the electric field E is generated along the longitudinal axis X1, and the magnetic field B is generated along the latitudinal axis X3. The resultant field of the crossed electric and magnetic fields is configured to separate the secondary electrons from the secondary ions based on a velocity and/or mass differential between the secondary electrons and the secondary ions.

The ion detection assembly utilizes the principle of the cross-product v×B, where the velocity of charged particles (v) interacts with a magnetic field (B) to create a Lorentz force that selectively separates secondary ions from secondary electrons. This force, perpendicular to both the particle velocity and the magnetic field, separate the secondary electrons from the secondary ions due to their difference in mass-to-charge ratios, resulting in distinct trajectories for each secondary ions and secondary electrons.

The crossed electric and magnetic fields E×B apply a resultant force F on the secondary electrons, propelling the secondary electrons 116 along a first trajectory T1. The orientation of the force F depends on the orientation of the electric field E and the magnetic field, B. In the embodiment shown in FIGS. 2 and 3, the crossed E×B field produces a force F.

The first trajectory comprises a lateral component equal to the lateral second distance D2. Accordingly, the secondary electrons are directed to reach the exit aperture 176 and thereout to the sensor unit 140. The resultant force F is applied on the secondary ions 124 propelling the secondary ions 124 along a second trajectory comprising a lateral component not equal (typically longer but may be shorter) than the lateral second distance D2. In some embodiments, the second trajectory may reach the entrance plate 170 and thus the secondary ions 124 are absorbed therein. In some embodiments, typically for secondary negative ions the second trajectory T2 reaches farther than the exit aperture, as shown for example in FIG. 2. In some embodiments, typically for secondary positive ions, the second trajectory T3 is directed to opposite direction along the lateral axis X2, as shown for example in FIG. 2.

The secondary ions 124 are thereby prevented from reaching the exit aperture 176 by causing them to be diverted away from the exit aperture 176 and remain within the particle selector 130, typically being absorbed within the converter plate 160 or the entrance plate 170.

The magnetic field is optionally homogeneous and is predetermined to a degree operable to guide the secondary electrons to the exit aperture and thereout.

Magnetic field B may be generated in any suitable manner, such as by a magnet assembly 182 providing the magnetic field B within the region 180.

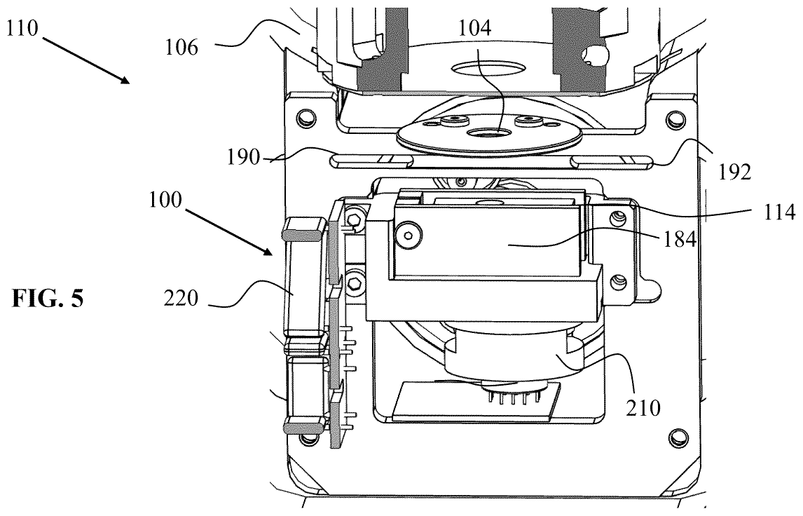

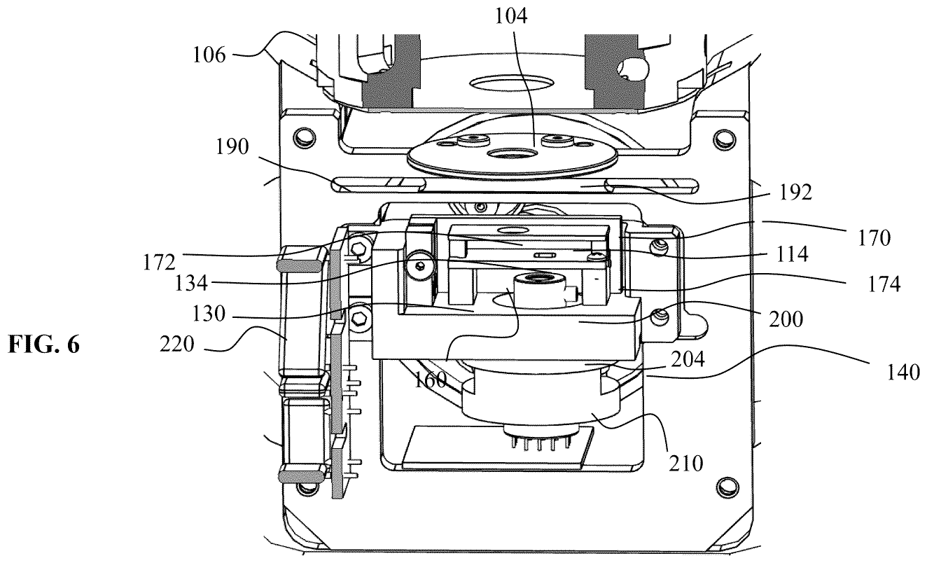

In some embodiments, the magnet assembly is formed by walls within which the magnetic field B is generated. The geometry of the walls, the magnetic field, and the predetermined electric field are configured such that at least a majority of the secondary ions impinge at least one of the walls. In some embodiments, the geometry of the walls, the magnetic field, and the predetermined electric field are configured such that all the secondary ions impinge at least one of the walls. The magnet assembly 182 comprises a single or plurality of permanent magnets or electromagnets configured to generate the magnetic field B, which may be a homogeneous or non-homogeneous magnetic field. In some embodiments, as shown in FIGS. 5 and 6, the magnetic assembly 182 comprises two oppositely facing permanent magnets formed as walls 184, it being appreciated that any suitable means for generating a magnetic field may be provided. In some embodiments, the magnetic assembly may comprise one or more magnets accompanied by pole pieces configured to generate the magnetic field B.

In some embodiments, the electrical shield mechanism 120 is configured to isolate the exit opening 104 from the converter assembly 114 in any suitable manner.

As seen in the example of FIG. 2, the electrical shield mechanism may comprise a gap D3 formed between the exit opening 104 and the entrance plate 170, for distancing the converter assembly 114 from the exit opening 104 to a degree in which the converter assembly 114 does not electrically bias the exit opening 104.

In a non-limiting example, the length of the gap D3 may be based upon the condition of: E<100 V/mm, namely that the electric field E on the entrance plate 170 is less than 100 Volts per millimeter of a potential difference. Accordingly, the gap D3 may comprise at least a length of at least 1 millimeter long for every 100 volts on the entrance plate 170. Thus, for an entrance plate biased with 10 kV, the gap D3 comprises a length of at least 100 millimeters or even 150 millimeters.

As seen in the example of FIG. 3, the electrical shield mechanism 120 may comprise at least one electrode 190 positioned axially intermediate the exit opening 104 and the converter assembly 114. The one or more electrodes 190 are formed with an electrode opening 192 axially aligned with the exit opening 104 for directing the primary ions 102 from the ion analyzer 106 through the electrode 190 to the converter assembly 114 via the entrance plate 170.

In some embodiments, the ion analyzer is operable to separate different types of primary ions based on their stability of motion within an oscillating electric field. In a non-limiting example, the ion analyzer comprises any one of a quadrupole and an ion trap. Typically, primary ions 102 exit therefrom at relatively low energies, such as in the range of 0 to 100 volts, in a non-limiting example. In order to propel the primary ions 102 towards the entrance plate 170 and/or converter assembly 114, an accelerator may be provided for acceleration of the primary ions from the exit opening towards the converter assembly.

The accelerator may be formed of any configuration for attracting the primary ions from the exit opening thereto and therethrough. In some embodiments, the one or more electrodes 190 may be utilized for operating as an accelerator.

Any one of the entrance aperture 172, the exit aperture 176 and the electrode opening 192 may be formed as a window, grid, mesh, a slit or any other type of aperture of any appropriate size to allow the ions and/or electrons therethrough.

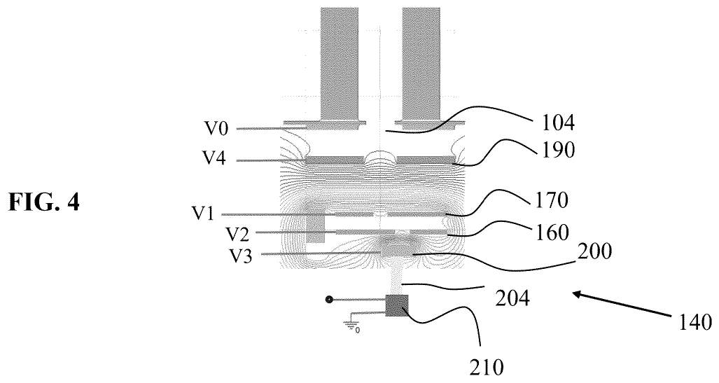

In some embodiments, as shown in FIG. 4, the sensor unit 140 comprises a scintillator 200 formed with a scintillating surface for generating a photon upon impingement of the secondary electron 116 thereon, and a light guide 204 for passage of the photons therethrough to a light sensor 210 operative to generate a signal based upon the photons.

In some embodiments, the light sensor 210 may comprise any one of a Photomultiplier Tube (PMT) and a Hybrid Photodetector (HPD). In some embodiments, the light sensor 210 may comprise a vacuum-compatible light sensor comprising a housing formed of vacuum-compatible materials and configured for housing a photocathode and a semiconductor diode. The photocathode is configured for converting an impinging photon to a photoelectron, and the semiconductor diode is configured for multiplying the photoelectron impinging thereon.

The vacuum-compatible light sensor is configured for being positioned in a vacuum chamber.

In some embodiments, the converter assembly is selectively electrically biasable in dual polarity modes including: a positive mode operable for attracting positive primary ions thereto and a negative mode operable for attracting negative primary ions thereto.

The converter assembly may further be operable to directly convert positive primary ions and negative primary ions directly to secondary electrons, free of intermediate conversion stages.

As seen in FIG. 4, a non-limiting example of a biasing scheme of the ion detection system is shown. The potential or the voltage at the exit opening 104 is denoted by V0. Any one or more of the following elements are electrically biasable: the entrance plate 170 is biased to V1, the converter plate 160 is biased to V2, the scintillator 200 is biased to V3 and in some embodiments, the electrode 190 is biased to V4.

By way of a non-limiting example, the voltage at the exit opening V0=0 volts. During the positive mode, the electrode 190 is biased to V4=−250 volts to attract the positive ions thereto. The entrance plate 170 is biased to V1=−9.75 kV, thereby attracting the positive ions thereto and further to the converter plate 160 which is biased to V2=−10 kV. The scintillator 200 is biased to V3=−5 kV to attract converted secondary electrons thereto.

During the negative mode, the electrode 190 is biased to V4=+250 volts to attract the negative ions thereto. The entrance plate 170 is biased to V1=+10.25 kV, thereby attracting the negative ions thereto and further to the converter plate 160 which is biased to V2=+10 kV. The scintillator 200 is biased to V3=+15 kV to attract converted secondary electrons thereto.

An electrical biasing assembly 220 may be provided. The electrical biasing assembly 220 may comprise any wired and/or wireless means for biasing the components, such as, but not limited to, voltage dividers, means for power/voltage supplies, etc.

In a further non-limiting example, the trajectory of the secondary electrons is defined by parameters Ymax and Xmax.

Ymax represents the maximum axial distance between the converter plate and the entrance plate. It defines the spatial spacing within the system to maintain an optimal electric field in the region formed by this distance. In a non-limiting example, constraining Ymax ensures efficient interaction between the primary ions and the converter assembly while minimizing field distortions. The system may be designed such that Ymax is below a predefined threshold, at times strictly below a predefined threshold, and often under 3 units, and more preferably under 2 units, to ensure precise particle control and separation. A unit may be measured by

$$\frac{D ( \frac{m}{q} )}{B} .$$

in which, D is equal to \sqrt{V/(B·d)}, m being the mass of an electron in Kilograms, q being the charge of an electron in ESU, B being the value of the magnetic field within the region expressed in Tesla, V being the voltage in Volts between the entrance plate and the conversion plate (i.e. V1 minus V2) and d being the distance between the entrance plate and the conversion plate in meters, namely D1. The value of m/q is equal to m/q=5.686.10⁻¹² kg/C. Ymax may be a measure for D1, in some embodiments.

Xmax represents the maximum lateral distance between the converter plate and the exit aperture. It governs the transverse spacing to facilitate the accurate trajectory of secondary electrons toward the sensor unit. Limiting Xmax ensures that secondary electrons are directed efficiently through the exit aperture while preventing unintended particle dispersion or ion interference. Similar to Ymax, Xmax is maintained under a predefined limit for optimal system performance and in some embodiments, the Xmax strictly is maintained under a predefined limit for optimal system performance and in some embodiments.

In some embodiments, maximum distance Xmax of a second distance between the converter plate and the exit aperture is in the range of, including the minimal and maximal values:

$$2 * 1 {0}^{- 11} \frac{V}{{B}^{2} d} \leq X max \leq {10}^{- 10} \frac{V}{{B}^{2} d} .$$

in which Vis the voltage in Volts between the entrance plate and the conversion plate d is the distance between the entrance plate and the conversion plate in meters, D1; B is the value of the magnetic field expressed in Tesla.

Xmax may be a measure for D2, in some embodiments.

FIGS. 5 and 6 illustrate the ion detection assembly implemented in a chamber of a mass spectrometry device. FIG. 6 is similar to FIG. 5, yet it shows a front wall of the magnet assembly removed for clarity.

The primary ions 102 are emitted from the exit opening 104 of the ion analyzer 106 forming part of a mass spectrometry device 110.

The ion detection system 100 comprises the electrically biasable converter assembly 114 being operable to generate secondary electrons 116 upon impingement of the primary ions 102 thereon. The electrical shield mechanism is provided and comprises the electrode 190.

The particle selector 130 is provided and is formed with an exit aperture 134 for exit of particles therefrom towards the sensor unit 140.

The sensor unit 140 is operable for the impingement of the secondary electrons 116 exiting the exit aperture 134 and for generating the signal indicative of the primary ions 102.

While various inventive embodiments have been described and illustrated herein, those of ordinary skill in the art will readily envision a variety of other means, materials, or structure for performing the function, obtaining the results, or one or more of the advantages described herein, and each of such variations or modifications is deemed to be within the scope of the inventive embodiments described herein. More generally, those skilled in the art will readily appreciate that all parameters, dimensions, materials, and configurations described herein are meant to be for example only and that the actual parameters, dimensions, materials, and configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims, equivalents thereto, and any claims supported by the present disclosure, inventive embodiments may be practiced otherwise than as specifically described and claimed. Inventive embodiments of the present disclosure are directed to each individual feature, system, article, material, composition, kit, method, and step, described herein. In addition, any combination of two or more such features, systems, articles, materials, compositions, kits, methods, and steps, if such features, systems, articles, materials, compositions, kits, methods, and steps, are not mutually inconsistent, is included within the inventive scope of the present disclosure.

Embodiments disclosed herein may also be combined with one or more features, functionality, or materials, as well as complete systems, devices or methods, to yield yet other embodiments and inventions. Moreover, some embodiments, may be distinguishable from the prior art by specifically lacking one and/or another feature disclosed in the particular prior art reference(s); i.e., claims to some embodiments may be distinguishable from the prior art by including one or more negative limitations.

Also, as noted, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” Consisting essentially of,” when used in the claims, shall have its ordinary meaning as used in the field of patent law.

1. An ion detection system for detecting primary ions emitted from an exit opening of an ion analyzer, comprising:
an electrically biasable converter assembly being operable to generate secondary electrons upon impingement of the primary ions thereon;
an electrical shield mechanism operable to reduce the electric field generated by the converter assembly on the exit opening;
a particle selector formed with an exit aperture and being operable to direct the secondary electrons out of the exit aperture and to prevent propagation of secondary ions generated by the converter assembly, through the exit aperture; and
a sensor unit operable for impingement thereon of the secondary electrons exiting the exit aperture and for generating a signal indicative of the primary ions.

2. The system according to claim 1, wherein the particle selector comprises crossed electric and magnetic fields operable to perform said directing of the secondary electrons out of the exit aperture and said preventing the propagation of the secondary ions through the exit aperture.

3. The system according to claim 2, wherein the converter assembly comprises:
an entrance plate formed with an entrance aperture for allowing passage therethrough of the primary ion emitted from the exit opening;
a converter plate and a converter member supported by the converter plate, the particle selector comprises an exit plate formed with the exit aperture; and
the converter plate is arranged at a first distance from the entrance plate and the exit plate is more proximal to the exit opening,
each of the converter plate and the exit plate is electrically biasable relative to the entrance plate to create the electric field in a region formed by said first distance.

4. The system according to claim 3, wherein:
the first distance extends along a longitudinal axis of the system,
the converter plate and the exit plate are positioned along a lateral axis of the system,
the electric field is generated along the longitudinal axis, and
the magnetic field is generated along a latitudinal axis which is orthogonal to the longitudinal axis and the lateral axis.

5. The system according to claim 3, wherein the particle selector comprises a magnet assembly providing the magnetic field within the region and a resultant field of the crossed electric and magnetic fields is configured to separate the secondary electrons from the secondary ions based on a velocity differential between the secondary electrons and the secondary ions.

6. The system according to claim 5, wherein a maximum axial distance Yₘₐₓ of the first distance between the converter plate and the entrance plate is strictly under
$$3 \cdot \frac{D ( \frac{m}{q} )}{B} ,$$
where D is equal to \sqrt{V/(B·d)}, m being the mass of an electron in g, q being the charge of an electron in ESU, B being the value of the magnetic field within the region in Tesla, V being the voltage in Volts between the entrance plate and the conversion plate and d being the distance between the entrance plate and the conversion plate in m.

7. The system according to claim 6, wherein a maximum distance Xmax of a second distance between the converter plate and the exit aperture is in the range of, including the minimal and maximal values:
$$2 * 1 {0}^{- 11} \frac{V}{{B}^{2} d} \leq X max \leq {10}^{- 10} \frac{V}{{B}^{2} d} .$$

8. The system according to claim 3, wherein the magnet assembly is formed by walls within which the magnetic field is formed, the system being configured to impose a predetermined said electric field crossed with said magnetic field within said walls, a geometry of the walls, the magnetic field, and the predetermined electric field being configured such that at least a majority of the secondary ions impinge at least one of the walls.

9. The system according to claim 8, wherein the resultant field is operable to:
guide the secondary electrons along a first trajectory that directs the secondary electrons through the exit aperture, and
guide the secondary ions along a second trajectory that diverts the secondary ions away from the exit aperture.

10. The system according to claim 1, wherein the primary ions are emitted from the ion analyzer, and any one or more of:
emitted at low energies in the range of 0-100 volts; and
the ion analyzer which is operable to separate different types of primary ions based on their stability of motion within an oscillating electric field.

11. The system according to claim 1, wherein the primary ions are emitted from the ion analyzer comprising any one of a quadrupole and an ion trap.

12. The system according to claim 1, wherein the electrical shield mechanism isolates the exit opening from the converter assembly.

13. The system according to claim 3 wherein the electrical shield mechanism comprises a gap formed between the exit opening and the entrance plate.

14. The system according to claim 13, wherein the gap comprises a length at least 1 millimeter long for every 100 volts charge on the entrance plate.

15. The system according to claim 1, wherein the electrical shield mechanism comprises at least one electrode positioned axially intermediate the exit opening and the converter assembly and is formed with an electrode opening axially aligned with the exit opening.

16. The system according to claim 15, wherein the electrode comprises an accelerator for acceleration of the primary ions from the exit opening towards the converter assembly.

17. The system according to claim 1, wherein the sensor unit comprises a scintillator formed with a scintillating surface for generating a photon upon impingement of the secondary electron thereon and a light guide for passage of the photons therethrough to a photomultiplier tube operative to generate said signal based upon the photons.

18. The system according to claim 1, wherein the converter assembly is selectively electrically biasable in dual polarity modes including:
a positive mode operable for attracting positive primary ions thereto; and
a negative mode operable for attracting negative primary ions thereto.

19. The system according to claim 1, wherein the converter assembly is operable to directly convert positive primary ions and negative primary ions directly to secondary electrons, free of intermediate conversion stages.

20. An ion detection system for selectively detecting primary positive ions and negative primary ions, emitted from an exit opening of an ion analyzer, comprising:
an electrically biasable converter assembly being operable to generate secondary electrons upon impingement of the primary ions thereon;
an electrical shield mechanism operable to reduce the electric field generated by the converter assembly on the exit opening;
a particle selector formed with an exit aperture and being operable to direct the secondary electrons out of the exit aperture and to prevent propagation of secondary ions generated by the converter assembly, through the exit aperture;
a sensor unit operable for impingement thereon of the secondary electrons exiting the exit aperture and for generating a signal indicative of the primary ions
wherein the converter assembly is selectively electrically biasable in dual polarity modes including:
a positive mode operable for attracting positive primary ions thereto; and
a negative mode operable for attracting negative primary ions thereto.
